(19) United States
(12) Patent Application Publication
(10) Pub. No.: US 2026/0112203 A1
(43) Pub. Date: Apr. 23, 2026

(54) SYSTEMS AND METHODS FOR MOVEMENT VIDEO ANALYSIS

(71) Applicant: MeasuredAI Corp, Calgary (CA)

(72) Inventor: Thomas WILSON, Calgary (CA)

(73) Assignee: MeasuredAI Corp, Calgary (CA)

(21) Appl. No.: 19/358,493

(22) Filed: Oct. 15, 2025

Related U.S. Application Data
(60) Provisional application No. 63/710,145, filed on Oct. 22, 2024.

(51) Int. Cl. G06V 40/20; A63B 24/00

(52) U.S. Cl. CPC G06V 40/23; A63B 24/0006; A63B 2024/0015

(57) ABSTRACT

A system and method for analyzing human movement in video data is disclosed. Image data of a person performing an exercise is captured and processed using pose and object detection to generate metadata representing body part positions and angles. A sequence generator applies logical and arithmetic rules to the metadata to identify exercise repetitions through triggers and waypoints. A state machine tracks progression through the waypoints to determine repetition completion. Repetition confidences are determined and aggregated into an exercise confidence, which is used to identify the performed exercise and orientation. The system annotates video data with metric gates and corrects occlusions using geometric estimation. The system and method enable automated analysis of exercise movements for applications in fitness, sports, rehabilitation, and performance monitoring.

### FIELD

The present invention relates generally to systems to analyze video or images of movement. More particularly, the present invention relates to methods and systems for video analysis of a pose and movement of one or more humans performing exercise movements.

### BACKGROUND

“A Comprehensive Guide on Human Pose Estimation” by Walia, Mrinal Singh, Data Science Blogathon, 10 Feb. 2022 describes human Pose estimation based on a computer vision task that represents the orientation of a person in a graphical format. The technique is applied to predict a person’s body parts or joint position. The article covers open-source pose estimation projects, (e.g. OpenPose, PoseDetection, DensePose, AlphaPose, HRNet) on Github along with some state-of-the-art models, techniques, and types of pose estimation.

### SUMMARY

Any and/or all aspects as described herein may be implemented in any and/or all combinations.

According to an aspect, there is provided a system to analyze a movement pattern in video data, comprising: at least one camera that captures image data of a person performing an exercise; a computing structure comprising a processor, a memory, and a plurality of instructions. The plurality of instructions may configure the processor to: generate metadata from the image data, the metadata comprising at least one position and at least one angle of at least one body part of the person; track the at least one position and the at least one angle from the metadata to generate at least one measurement; determine at least one trigger based on the at least one measurement and at least one target range; group the at least one trigger into at least one waypoint representing a stage of an exercise repetition; generate a sequence of waypoints corresponding to a repetition of the stage; track a progression through the sequence of the at least one waypoint with a state machine; and determine a completion of the repetition based on the progression. The state machine may apply a hysteresis to the at least one trigger to reduce at least one spurious transition. The instructions may configure the processor to present an annotated data-time series including at least one measurement plot and at least one metric plot with at least one metric gate.

In some aspects, the instructions may configure the processor to determine a repetition confidence based on the completion of the progression; and combine a plurality of the repetition confidence to determine an exercise confidence. The instructions may configure the processor to remove at least one of the repetition confidences from the exercise confidence when the repetition confidence being below a threshold. The instructions may configure the processor to perform a comparison of the exercise confidence to a plurality of exercise types; and select a detected exercise based on a highest exercise confidence from the comparison. The instructions may configure the processor to determine an exercise orientation by determining a mirrored exercise confidence and a nominal exercise confidence.

According to another aspect, the instructions may configure the processor to identify the at least one body part as at least one of: an eye, an ear, a shoulder, a knee, a hip, an elbow, a wrist, and an ankle.

The instructions may configure the processor to detect at least one object in the image data; and determine an object type, an object position, and an object motion for the at least one object. The instructions may configure the processor to estimate the at least one position and the at least one angle for an occluded portion of the body part derived from at least one of: an expected waypoint, a static body part geometry, and mirrored waypoint data from at least one visible body part.

According to an aspect, there is provided a method for analyzing movement patterns in video data. The method may comprise: capturing image data from at least one camera; generating metadata from the image data, the metadata representing at least one position and at least one angle of at least one body part of a person; tracking the at least one position and the at least one angle from the metadata to generate at least one measurement; determining at least one trigger based on the at least one measurement and at least one target range; grouping the at least one trigger into at least one waypoint representing a stage of an exercise repetition; generating a sequence of waypoints corresponding to a repetition of the stage; tracking a progression through the sequence of the at least one waypoint with a state machine; and determining a completion of the repetition based on the progression. The state machine applies a hysteresis to the at least one trigger to reduce at least one spurious transition. The method may further comprise presenting an annotated data-time-series on a display, the annotated data-time-series including at least one measurement plot and at least one metric plot with at least one metric gate.

The method may further comprise determining a repetition confidence based on the completion of the progression; and combining a plurality of the repetition confidences to determine an exercise confidence. The method may further comprise removing at least one of the repetition confidences from the exercise confidence when the repetition confidence being below a threshold. The method may further comprise performing a comparison between the exercise confidence to a plurality of exercise types; and selecting a detected exercise based on a highest exercise confidence from the comparison. The method may further comprise determining an exercise orientation by determining a mirrored exercise confidence and a nominal exercise confidence.

According to another aspect, the method may further comprise identifying the at least one body part as at least one of: an eye, an ear, a shoulder, a knee, a hip, an elbow, a wrist, and an ankle.

The method may further comprise detecting at least one object in the image data; and determining an object type, an object position, and an object motion for the at least one object. The method may further comprise estimating the at least one position and the at least one angle for an occluded portion of the body part derived from at least one of: an expected waypoint, a static body part geometry, and mirrored waypoint data from at least one visible body part.

### BRIEF DESCRIPTION OF THE DRAWINGS

An embodiment will now be described, by way of example only, with reference to the attached Figures, wherein:

FIG. 1A is a block diagram demonstrating a video capture of an exercise subject to produce a video data series;

FIG. 1B is a computing structure configured to execute one or more processes herein;

FIG. 2 is a diagram of a sequence generator for determining a sequence based on one or more video-based measurements;

FIG. 3 is a state machine for determining one or more waypoints of a repetition;

FIG. 4 is a diagram for combining repetition confidences into an exercise confidence;

FIG. 5 is a diagram for determining a detected exercise using a selector;

FIG. 6 is an annotated data-time-series demonstrating two metric gates for an example exercise; and

FIG. 7 is a diagram of a person exercising demonstrating an occlusion.

### DETAILED DESCRIPTION

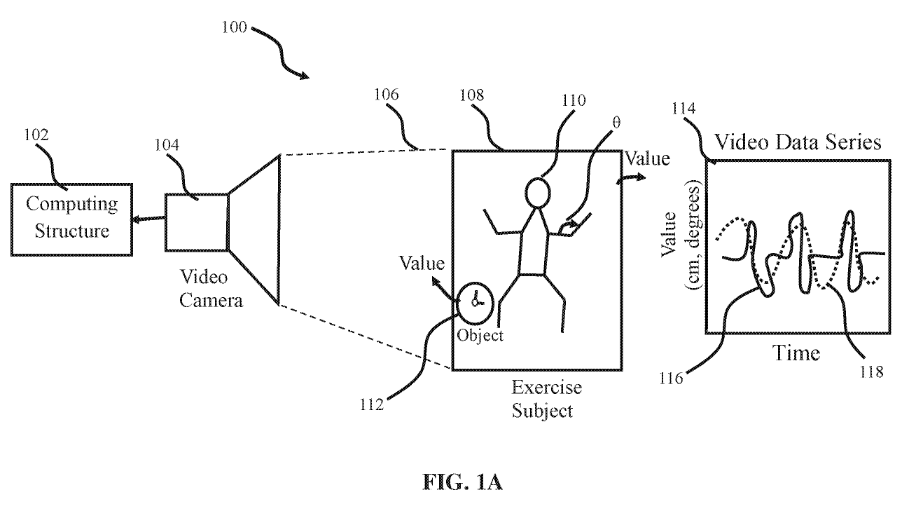

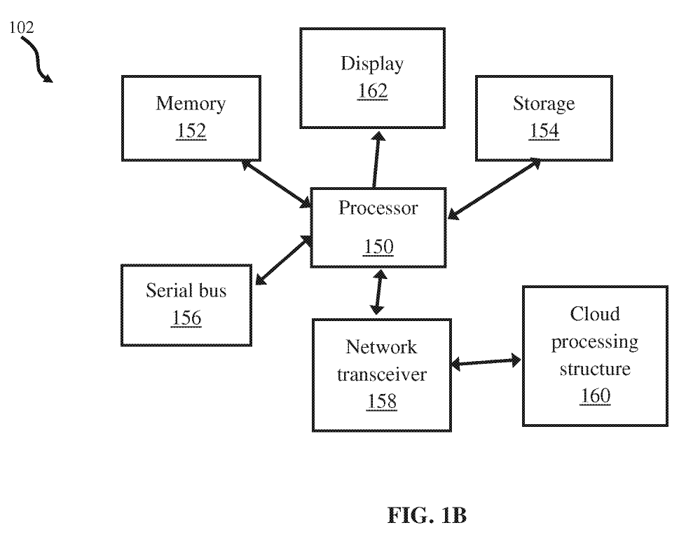

Turning to FIGS. 1A and 1B, a system 100 to analyze a movement pattern in video data is shown. The system 100 comprises a computing structure 102 that may receive one or more images (e.g. image data 108) from one or more cameras 104 over a serial bus 156. In some aspects, the computing structure 102 may receive video or image data that may be separated into individual images, each representing a video frame. The camera 104 may have a field of view 106 of a person 110 (or people) performing an exercise. The camera 104 is configured to capture image data or video data. One or more joints of the person 110 may form at least one angle θ or angles. For the sake of convenience, only one of the joints in FIG. 1 is labelled, θ. In some aspects, the image data 108 may also comprise one or more objects 112, which may have an object position and/or an object motion within the image data 108. A combination of the angles θ may form a posture of the person 110. The image data may be processed by the processor 150 of the computing structure 102 to produce one or more video data series 114, as described in further detail below, comprising measurement values (e.g. degrees, centimeters) over time. In this aspect, the video (or time) data series 114 comprises one or more angle measurement plots 118 and a position plot 116.

The image data may be processed by a human pose detector and/or one or more object detectors executed by one or more processors 150 of the computing structure 102. The human pose detector may comprise a plurality of instructions that reside in memory 152 to be executed by the processor 150. The human pose detector may process image pixels of the image data and may output metadata outlining one or more body positions and/or angles for a body part or body parts of the person 110. The metadata may be stored in either memory 152, such as random-access memory, or in storage 154, such as a solid-state drive (SSD) or hard disk drive (HDD). In this aspect, the body parts may be selected from one or more of: eye, ear, mouth, nose, shoulder, knee, hip, elbow, wrist, and/or ankle but are not limited to these body parts. The object detectors may reside in memory 152 and may process the image data to provide object data, such as an object type, an object position, and/or an object motion for each of the detected objects 112. The human pose detector and/or the object detectors may then successively process the image data from memory 152 and/or storage 154 by tracking the positions and/or angles of the body parts of the person 110 and/or the object position and/or the object motion of the objects 112 over time to produce the time-data series 114. The time-data series 114 may be stored in a computer-readable medium, such as memory 152 or storage 154. In some aspects, the processor 150 may provide the image data to a network transceiver 158 and the human pose detector and/or the object detectors may process the image data using a cloud processing structure 160 (or may be processed locally on the processors 150), which may transfer the metadata and/or the object data back to the network transceiver 158 for further processing by the processor 150. In some aspects, the metadata and/or the object data may be plotted on one or more graphs to a display 162.

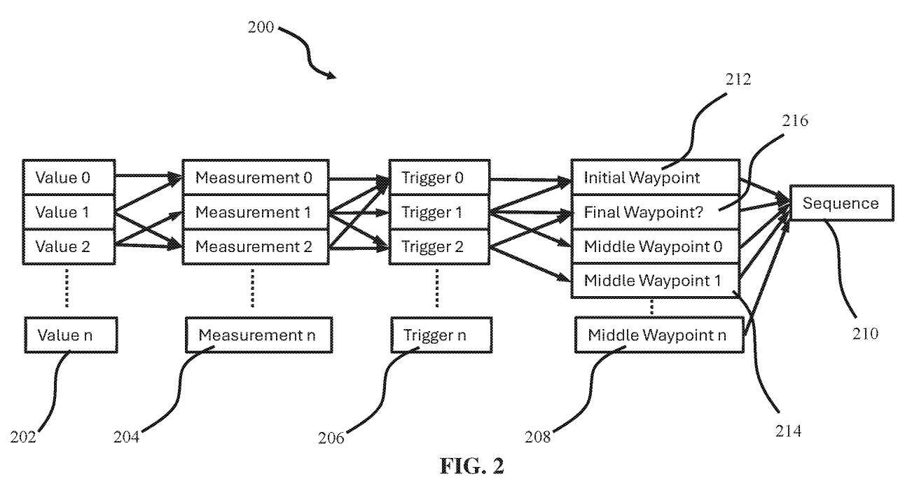

Turning to FIG. 2, the time-data series 114 may be processed by a sequence generator 200 into one or more intervals representing one or more portions of repetitions of a movement pattern, such as exercise, sports, physical activity, physiotherapy, dance, etc. In this aspect, the sequence generator 200 may execute on the processor 150 and may be a network of stages having a value stage 202, a measurement stage 204, a trigger stage 206, and a waypoint stage 208.

For individual images from the image data, the metadata may be combined to form one or more values in the value stage 202 incorporating positions (x, y, z) and/or angles for body parts of the person 110 and interrelationships between each of the body parts and an absolute coordinate space (e.g. angles, positions, lengths, motion detection, etc.). In some aspects, the combinations of the metadata may involve combining one or more immediate values, one or more corresponding previous values (e.g. derivation), and/or one or more future values (e.g. normalization to range seen in entire dataset) together. Single or multiple data values may be combined by the processor 150 using one or more logical and/or mathematical rules to form one or more measurements in the measurement stage 204 that link together the individual data values, such as by a difference, an offset, an average, and/or a distance. Some aspects may combine the individual data values using the immediate value, the previous value, and/or the future values, such as for example, a rate of change, a force/power, a rate of acceleration, a deviation from a start, a comparison with the positions and/or angles of other joints, a normalized range, and/or a movement detection.

For a particular exercise, each exercise may be a set of pre-set logical, combinational, and/or arithmetic rules forming a recipe for the exercise. These sets of rules may be flexible which leads to the visualization with a bunch of arrows that look like neural connections in the image. For a simplified example, for a squat exercise the set of rules may particularly identify 90-degree bent legs. In this example, Value 1 comprises Left Leg bend measured as angle (hip-knee-ankle); Value 2 comprises Right leg bend measured as angle (hip-knee-ankle); Measurement 1 comprises "Left Leg" with single value (Value 1); and Measurement 2 comprises "Right Leg" with single value (Value2). The Initial Waypoint may be Trigger "Left Leg" at -10 to +10 degrees and Trigger "Right Leg" at -10 to +10 degrees. The Middle Waypoint 1 may be Trigger "Left Leg" +10 to +80 degrees and Trigger "Right Leg" at +10 to 80 degrees. The Final Waypoint may be Trigger "Left Leg" > 80 degrees and Trigger "Right Leg" > 80 degrees. The Squat exercise sequence is specified by these waypoints. In practice, the number of sequences is more complicated than this simple example to capture finer details and to allow more robust detection.

Once the measurements are determined, one or more triggers in the trigger stage 206 may be calculated from the measurements with target ranges, which may be specified as met or unmet depending on the measurement relative to the target ranges (e.g. in range, out of range, below, above, equal to, etc.). The target range may be determined by specifying a typical body position that the subject progresses through to complete a repetition of the exercise. For example, in a squat exercise, the exerciser may start with a knee angle substantially at 180-degrees (with margin for measurement error), then progress through to a bent state (e.g. the knee angle substantially less than 180-degrees), before returning to a straight legged state. The target range may be defined around these exercise-specific positions to synchronize to forward progression through an exercise repetition. One or more of the triggers may then be grouped into one or more waypoints in the waypoint stage 208, such that the waypoint is set to be active when the triggers are met for the respective waypoint. In this aspect, the waypoints may comprise an initial waypoint 212 and one or more middle waypoints 214. In some aspects, a final waypoint 216 may supersede any of the middle waypoints 214 and terminate the current repetition in the sequence 210.

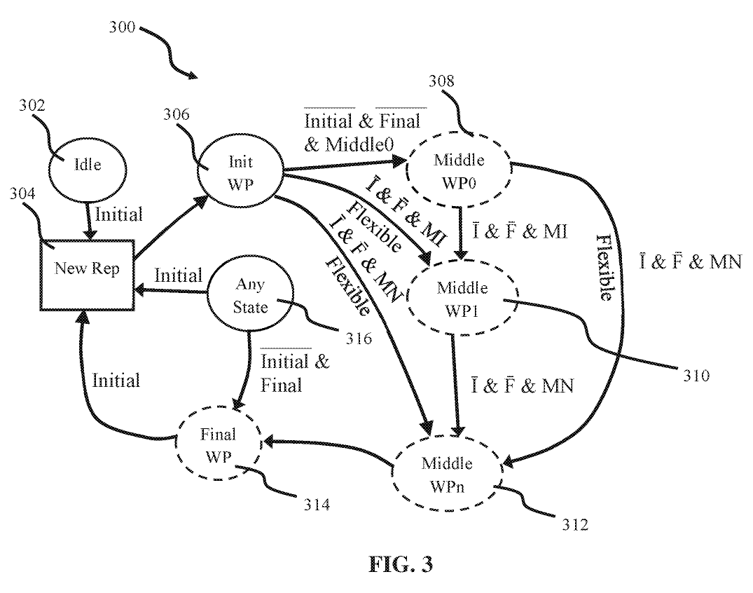

A sequence 210 of the waypoints may then be created based at least on the initial waypoint 212, zero or more middle waypoints 214, and/or a final waypoint, which corresponds to a last middle waypoint 214 before the waypoints repeat. The sequence 210 of the waypoints may be modelled as a state machine 300 as shown in FIG. 3 based on the following steps. The state machine 300 starts in an idle state 302 before transitioning into a new repetition state 304. When initial waypoint state 306 is met, any currently ongoing repetition may end.

Treatment of the middle waypoints may be of strict-sequence activity or a flexible-sequence activity. The state machine 300 may apply hysteresis to all or some of the triggers depending on when a current waypoint is active where a wider range may be applied for when the waypoint is active. The hysteresis may enable one or more state transitions to be less noisy and/or reduce a spurious transition (or transitions) or an erroneous transition (or transitions).

When the initial waypoint state 306 is no longer met and in an absence of any final waypoint state 314 being met, the state machine 300 may determine a next middle waypoint state 308 in the strict-sequence activity or one of a set of unfulfilled middle waypoint states 310, 312 for the flexible-sequence activity. For the strict-sequence activity, when the next middle waypoint state 308 conditions are met, the state machine 300 progresses to that middle waypoint state 308, followed by the next middle waypoint state 310, and so forth. For the flexible-sequence activity, the state machine 300 progresses to a next identified middle waypoint state 308, 310, 312. In some aspects, once one of the middle waypoint states 308, 310, 312 has been identified, the state machine 300 may remove that middle waypoint state 308, 310, 312 from available middle waypoint states 308, 310, 312. Depending on several of the middle waypoint states 308, 310, 312, the state machine 300 may progress through the middle waypoint states 308, 310, 312 until no more middle waypoints states 308, 310, 312 are available. In another aspect, the state machine 300 may determine when a final waypoint state 314 at state 316 to determine when the sequence 210 is complete. In some aspects, proceeding backwards in the sequence 210 may not be permitted (e.g. after detecting middle waypoint state 310, the state machine 300 may mark the middle waypoint state 308 as skipped). When the final waypoint state 314 is met, the current repetition is finished. The state machine 300 then waits at the new repetition state 304 until the initial waypoint state 306 is identified again.

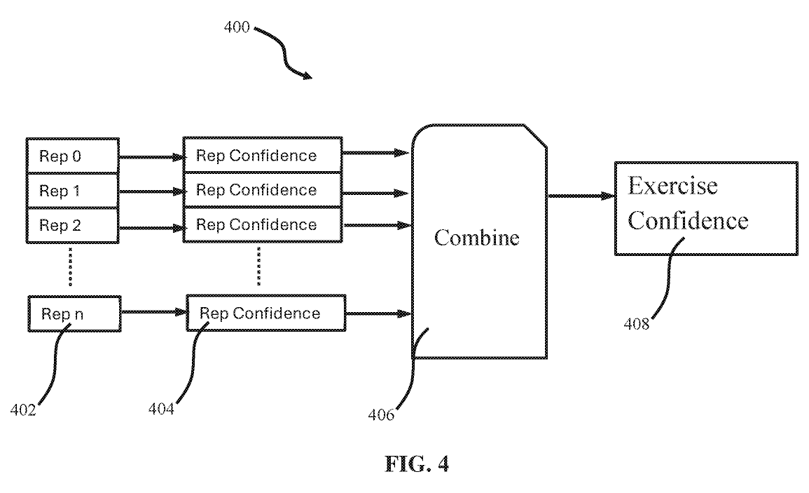

As shown in FIG. 4, a process flow 400 is shown. For each of the repetitions 402, waypoint data may be recorded in the storage 154 corresponding to which of the waypoint states 308, 310, 312 were completed for each repetition. Based on the waypoint data, one or more criteria may be determined for each repetition. For example, a repetition confidence 404 for each of the repetitions 402 may be calculated by combining (additively or otherwise) the number of waypoints completed during the repetition 402. The repetition confidences 404 may be combined in a combining step 406 to provide an overall exercise confidence 408 for the video data series 114. The combining step 406 may be performed with or without one or more weights based at least in part on timing information for each repetition. In other aspects, metrics may be recorded, such as measurement of the body/objects at a particular instantaneous point of the exercise (e.g. when entering/leaving a waypoint), maximum/minimum measurement value during the time between two waypoints, measurement deviation from a starting point from one waypoint to another, time duration taken to progress from one waypoint to another. For example, these metrics may be "barbell velocity", "lift time", "knee wander", "max knee bend", etc. depending on an exercise type.

Each of the repetition confidences 404 may be compared to a threshold to determine a spurious result and/or a repetition 402 that was prematurely stopped by the person. When the repetition confidence 404 does not meet the threshold, the repetition 402 may be removed from the exercise confidence 408.

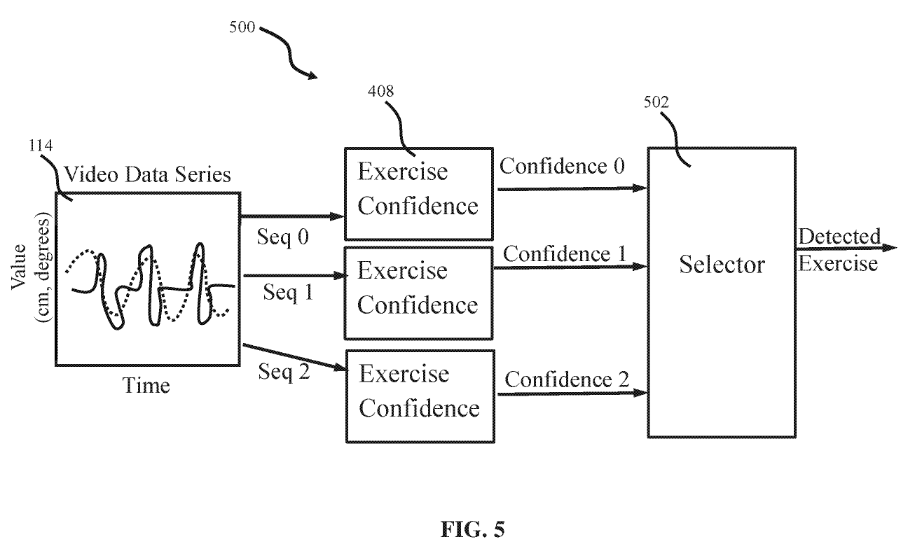

Turning to FIG. 5, the process 500 demonstrates the video data series 114 having a plurality of activities, each with an exercise confidence 408. In this aspect, the exercise confidences 408 may be provided to a selector 502. The selector 502 may detect an exercise orientation of the person and/or an exercise type (or exercise types) being performed. The selector 502 may comprise several sequences (i.e., recipes) representing different exercises or the same exercise with different person orientations. One or more repetition confidences may be determined by executing each sequence on the video data. The repetition confidences may be combined to form each sequence confidence. The selector 502 chooses the sequence with a highest sequence confidence value (e.g., a highest exercise confidence). For example, when left-facing deadlift gives an exercise confidence of 10, squat gives an exercise confidence of 3, and right-facing deadlift gives an exercise confidence of 2, then the system selects left-facing deadlift. Based on the exercise confidence 408, the computing structure 102 may determine whether the person is performing in a normal exercise orientation (e.g.: facing left, or starting with the left side of their body) or a mirrored exercise orientation (e.g.: facing right, or starting with the right side of their body) by performing a comparison (e.g., comparing) of the exercise confidence 408 when calculated with all measurements nominal and then mirrored geometrically (e.g.: left arm angle becomes right arm angle when mirrored) to generate a mirrored exercise confidence and a nominal exercise confidence. A higher exercise confidence 408 from the mirrored exercise confidence and the nominal exercise confidence may determine which orientation the person is facing.

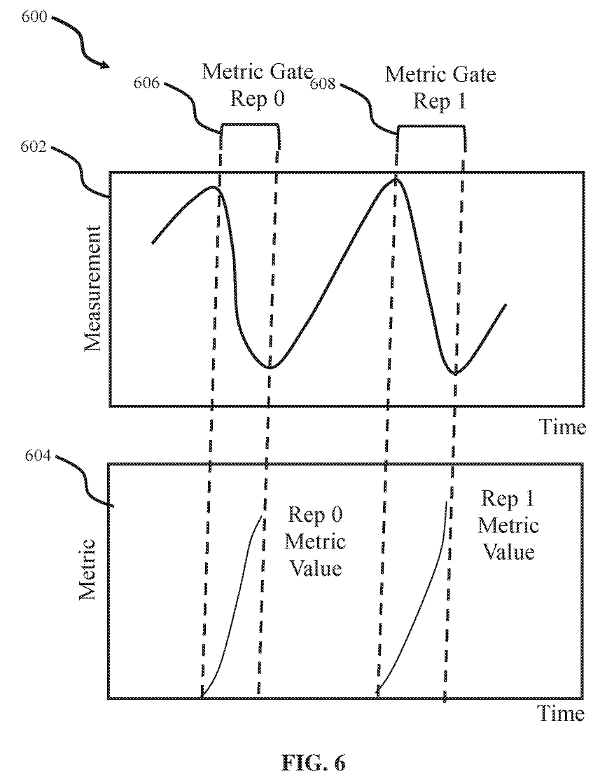

When the detected exercise and/or orientation is determined using the exercise confidence 408, the waypoint data for each repetition 402 may be overlaid on the video data series 114 to produce an annotated data-time-series 600 as shown in FIG. 6. The data-time-series 600 may provide a measurement plot 602 and/or a metric plot 604. Each repetition 402 may be labelled with a metric gate 606, 608 corresponding to a repetition metric value on the metric plot 604. In this aspect, a series of metric gates 606, 608 may have a start time and an end time based on a status of the waypoints (e.g., newly completed, last met value, first value after met, last value after met, and before next waypoint met, etc.), along with optional pre-time and post-time durations. The metric gates 606, 608 may be created by which measurements may be calculated based on the starting position and continue until the ending position is met. During metric gate 606, 608, the metric may be calculated based on one or more of: previous values, future values, maximum hold, averaging, deviation, deviation from other repetitions to allow for a calculation of metrics for each detected repetition.

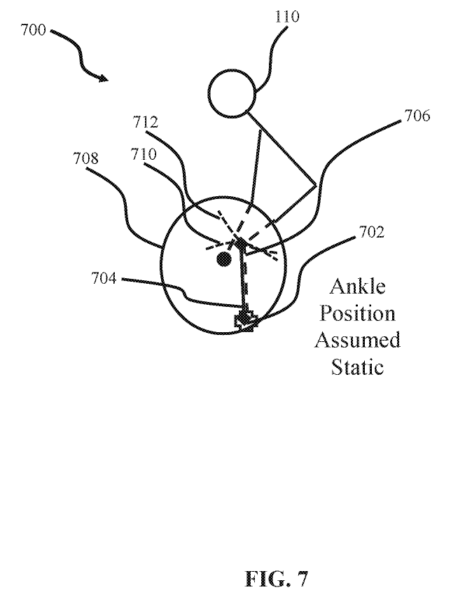

Turning to FIG. 7, in some aspects, during an example exercise 700, one or more objects 112 may occlude portions of the person 110 (e.g., an occluded portion of the body part), such as one or more arms, one or more legs, etc. For example, one of the legs 706 may be partially or completely occluded by a weight 708 that may cause distortion of joint positions of the leg. Other examples may have portions of exercise equipment occlude a portion of the person 110 (e.g. a wheel of an exercise bike). One or more post-processing techniques may be applied to the data-time-series 600 to provide estimates for gaps and/or errors in the waypoint data caused by the occlusions. The estimates may provide a more accurate body and/or object position during the occlusion events.

When the detected exercise has been determined, one expected waypoint or more expected waypoints may be associated with the detected exercise. Through comparison of the expected waypoints with the data-time-series 600, estimates may be determined based on the expected waypoints during the occlusion event. For example, when the detected exercise comprises relatively static positions (e.g. an ankle during a deadlift), then the post-processing may determine the position of the static body part 702 (e.g., the static body part geometry) during non-occluded portions of data-time-series 600 and then using the determined position to correct the data-time-series position during the occlusion event(s). In another example, an observed length of the body part, when visible, may be used to determine an estimated length of the body part when the body part becomes occluded (e.g. a static length 704 of a calf may be a constant throughout the lifting process). The estimated length may then be used to determine an estimated position of an occluded joint (e.g. ankle) based on the estimated length from a visible joint (e.g. the static length 704 of the calf from visible knee to determine estimated ankle position). Since the ankle is the static body part 702 and is fixed in place, the static length 704 of the calf may trace out a semicircle or arc 710 about a center of the ankle point. Similarly, a static length of the thigh may also form an arc 712 about a hip joint, which is visible in the present view. An intersection of these two of the arcs 710, 712 may be used to correct the detected position of the occluded knee. In other aspects, the arc 710 alone may be used to correct the detected position of the occluded knee.

Although particular limbs and joints are used herein, the aspects herein may be applied to other limbs and joints of a person 110.

In another example, a geometry of the person 110 may be determined for a visible body part (or visible body parts), which may be used to determine the position of the occluded body parts. For example, when the detected exercise is determined to be symmetrical, the waypoint data from one visible leg may be mirrored (e.g., mirrored waypoint data) to the other occluded leg.

Although the aspects herein disclose a two-dimensional image analysis, the techniques are applicable to a three-dimensional image analysis, for example, such as a stereo camera system or a camera system with two cameras from different vantage points, each with a field of view encompassing the person 110.

The above-described embodiments are intended to be examples and alterations and modifications could be affected thereto, by those of skill in the art, without departing from the scope, which is defined solely by the claims appended hereto.

What is claimed is:

1. A system to analyze a movement pattern in video data comprises:
at least one camera that captures image data of a person performing an exercise;
a computing structure comprising a processor, a memory, and a plurality of instructions to configure the processor to:
generate metadata from the image data, the metadata comprising at least one position and at least one angle of at least one body part of the person;
track the at least one position and the at least one angle from the metadata to generate at least one measurement;
determine at least one trigger based on the at least one measurement and at least one target range;
group the at least one trigger into at least one waypoint representing a stage of an exercise repetition;
generate a sequence of waypoints corresponding to a repetition of the stage;
track a progression through the sequence of the at least one waypoint with a state machine; and
determine a completion of the repetition based on the progression.

2. The system according to claim 1 further comprising the instructions to configure the processor to:
determine a repetition confidence based on the completion of the progression; and
combine a plurality of the repetition confidences to determine an exercise confidence.

3. The system of claim 2 further comprises the instructions to configure the processor to:
remove at least one of the repetition confidences from the exercise confidence when the repetition confidence being below a threshold.

4. The system according to claim 2 further comprises the instructions to configure the processor to:
perform a comparison between the exercise confidence to a plurality of exercise types; and
select a detected exercise based on a highest exercise confidence from the comparison.

5. The system of claim 4 further comprises the instructions to configure the processor to:
determine an exercise orientation by determining a mirrored exercise confidence and a nominal exercise confidence.

6. The system of claim 1 further comprises the instructions to configure the processor to:
identify the at least one body part as at least one of: an eye, an ear, a shoulder, a knee, a hip, an elbow, a wrist, and an ankle.

7. The system of claim 1, wherein the state machine applies a hysteresis to the at least one trigger to reduce at least one spurious transition.

8. The system of claim 1, further comprises a display and instructions to configure the processor to:
present an annotated data-time series including at least one measurement plot and at least one metric plot with at least one metric gate.

9. The system of claim 1 further comprises the instructions to configure the processor to:
detect at least one object in the image data; and
determine an object type, an object position, and an object motion for the at least one object.

10. The system of claim 9 further comprises the instructions to configure the processor to:
estimate the at least one position and the at least one angle for an occluded portion of the body part derived from at least one of: an expected waypoint, a static body part geometry, and mirrored waypoint data from at least one visible body part.

11. A method for analyzing a movement pattern in video data, the method comprising:
capturing image data from at least one camera;
generating metadata from the image data, the metadata representing at least one position and at least one angle of at least one body part of a person;
tracking the at least one position and the at least one angle from the metadata to generate at least one measurement;
determining at least one trigger based on the at least one measurement and at least one target range;
grouping the at least one trigger into at least one waypoint representing a stage of an exercise repetition;
generating a sequence of waypoints corresponding to a repetition of the stage;
tracking a progression through the sequence of the at least one waypoint with a state machine; and
determining a completion of the repetition based on the progression.

12. The method according to claim 11 further comprising:
determining a repetition confidence based on the completion of the progression; and
combining a plurality of the repetition confidences to determine an exercise confidence.

13. The method of claim 12 further comprising:
removing at least one of the repetition confidences from the exercise confidence when the repetition confidence being below a threshold.

14. The method according to claim 12 further comprising:
performing a comparison between the exercise confidence and a plurality of exercise types; and
selecting a detected exercise based on a highest exercise confidence from the comparison.

15. The method of claim 14 further comprising:
determining an exercise orientation by determining a mirrored exercise confidence and a nominal exercise confidence.

16. The method of claim 11 further comprising:
identifying the at least one body part as at least one of: an eye, an ear, a shoulder, a knee, a hip, an elbow, a wrist, and an ankle.

17. The method of claim 11, wherein the state machine applies a hysteresis to the at least one trigger to reduce at least one spurious transition.

18. The method of claim 11 further comprising:
presenting an annotated data-time-series on a display, the annotated data-time-series including at least one measurement plot and at least one metric plot with at least one metric gate.

19. The method of claim 11 further comprising:
detecting at least one object in the image data; and
determining an object type, an object position, and an object motion for the at least one object.

20. The method of claim 19 further comprising:
estimating the at least one position and the at least one angle for an occluded portion of the body part derived from at least one of: an expected waypoint, a static body part geometry, and mirrored waypoint data from at least one visible body part.
